(19) United States
(12) Patent Application Publication
(10) Pub. No.: US 2014/0086695 A1
(43) Pub. Date: Mar. 27, 2014

(54) PROCESSES AND APPARATUSES FOR MAKING CUTTING TOOL INSERTS

(71) Applicant: Kennametal Inc., Latrobe, PA (US)

(72) Inventors: Steven A. Jameson, Rockvale, TN (US); Michael R. Cripps, Murfreesboro, TN (US); Christopher J. Smith, Hermitage, TN (US); Terry Hammond, Smryna, TN (US); Robert K. Carlson, Goodlettsville, TN (US); John Dummermuth, Murfreesboro, TN (US)

(73) Assignee: Kennametal Inc., Latrobe, PA (US)

(21) Appl. No.: 13/626,185

(22) Filed: Sep. 25, 2012

(51) Int. Cl. B22F 3/02; B23B 27/16; B22F 1/00; B22F 3/03; B22F 3/12

(52) U.S. Cl. 407/64; 419/66; 419/38; 75/228; 425/78

(57) ABSTRACT

A process for the production of cutting tool inserts is described. A bottom punch is positioned into a powder compaction mold. A metallurgical powder is introduced into a mold cavity. A top punch is positioned into the powder compaction mold in an orientation opposed to the bottom punch. The metallurgical powder is compressed between the bottom punch and the top punch to form a powder compact. Also disclosed are cutting tool inserts produced in accordance with the process and powder pressing apparatuses for the production of cutting tool inserts.

### TECHNICAL FIELD

This disclosure relates to processes and apparatuses for pressing metallurgical powders to form powder compacts for the manufacture of cutting tool inserts. This disclosure also relates to the cutting tool inserts made using the processes and apparatuses.

### BACKGROUND

Modular cutting tools are one type of metal and alloy cutting tool that uses indexable cutting tool inserts that are removably attachable to a tool holder. Metal and alloy cutting tool inserts generally have a unitary structure and one or more cutting edges located at various corners or around peripheral edges of the inserts. Indexable cutting tool inserts are mechanically secured to a tool holder, but the inserts are adjustable and removable in relation to the tool holder. Indexable cutting tool inserts may be readily re-positioned (i.e., indexed) to present a new cutting edge to the workpiece or may be replaced in a tool holder when the cutting edges dull or fracture, for example. In this manner, indexable insert cutting tools are modular cutting tool assemblies that include at least one cutting tool insert and a tool holder.

Cutting tool inserts include, for example, milling inserts, turning inserts, drilling inserts, and the like. Cutting tool inserts may be manufactured from hard materials such as cemented carbides and ceramics. These materials may be processed using powder metallurgy techniques such as blending, pressing, and sintering to produce cutting tool inserts.

### SUMMARY

In a non-limiting embodiment, a process for the production of cutting tool inserts is described. The process comprises positioning a bottom punch into a powder compaction mold, introducing a metallurgical powder into a mold cavity, positioning a top punch into the powder compaction mold in an orientation opposed to the bottom punch, and compressing the metallurgical powder between the bottom punch and the top punch to form a powder compact. The bottom punch comprises a bottom punch body, a bottom punch face located on a pressing end of the bottom punch body, an internal channel disposed in the bottom punch body and opening at the bottom punch face, and a core rod partially disposed in the internal channel. The core rod comprises a pressing end and a countersinking projection located on the pressing end. The core rod partially extends through the opening of the internal channel and above the bottom punch face. The powder compaction mold and the bottom punch form the mold cavity. The top punch comprises a top punch body, a top punch face located on a pressing end of the top punch body, an internal channel disposed in the top punch body and opening at the top punch face, and a core pin disposed in the internal channel. The core pin comprises a pressing end and a countersinking projection located on the pressing end. The countersinking projection extends through the opening of the internal channel and below the top punch face.

In another non-limiting embodiment, a powder pressing apparatus for the production of cutting inserts comprises a bottom punch body, a core rod, a top punch body, and a core pin. The bottom punch body comprises a bottom punch face located on a pressing end of the bottom punch body. The bottom punch body also comprises an internal channel disposed in the bottom punch body and opening at the bottom punch face. The core rod is partially disposed in the internal channel of the bottom punch body. The core rod comprises a pressing end and a counter-sinking projection located on the pressing end. The core rod partially extends through the opening of the internal channel and above the bottom punch face. The top punch body comprises a top punch face located on a pressing end of the top punch body. The top punch body also comprises an internal channel disposed in the top punch body and opening at the top punch face. The core pin is disposed in the internal channel of the top punch body. The core pin comprises a pressing end and a countersinking projection located on the pressing end. The countersinking projection extends through the opening of the internal channel and below the top punch face.

In another non-limiting embodiment, a cutting tool insert comprises a top surface, a bottom surface, and a countersunk through-hole comprising a contiguous surface connecting the top surface and the bottom surface.

It is understood that the invention disclosed and described in this specification is not limited to the embodiments summarized in this Summary.

### BRIEF DESCRIPTION OF THE DRAWINGS

Various features and characteristics of the non-limiting and non-exhaustive embodiments disclosed and described in this specification may be better understood by reference to the accompanying figures, in which:

FIG. 1 is a side schematic view of a powder pressing apparatus comprising a top punch body and a bottom punch body aligned along a pressing axis;

FIG. 2 is a side schematic view of a core rod configured for use with the powder pressing apparatus illustrated in FIG. 1 for the pressing of powder compacts;

FIG. 3 is a side schematic view of the pressing ends of the top punch body and the bottom punch body illustrated in FIG. 1, wherein the core rod shown in FIG. 2 is partially disposed in the bottom punch body;

FIG. 4 is a cross-sectional schematic view of the powder pressing apparatus illustrated in FIG. 3 showing the compression and compaction of metallurgical powders to make a powder compact;

FIGS. 5A and 5B are perspective cross-sectional and side cross-sectional schematic views, respectively, of a powder compact made in the manner illustrated in FIG. 4.

FIG. 6 is a side schematic view of a powder pressing apparatus comprising a top punch body and a bottom punch body aligned along a pressing axis, wherein the top punch body comprises an integral core pin projection;

FIG. 7 is a side schematic view of the pressing ends of the top punch body and the bottom punch body illustrated in FIG. 6, wherein the powder pressing apparatus further comprises a core rod partially disposed in the bottom punch body;

FIG. 8 is a cross-sectional schematic view of the powder pressing apparatus illustrated in FIG. 7 showing the compression and compaction of metallurgical powders to make a powder compact;

FIGS. 9A and 9B are perspective cross-sectional and side cross-sectional schematic views, respectively, of a powder compact made in the manner illustrated in FIG. 8.

FIG. 10 is a side schematic view of a powder pressing apparatus comprising a top punch body and a bottom punch body aligned along a pressing axis;

FIG. 11 is a side schematic view of a core pin and a core rod configured for use with the powder pressing apparatus illustrated in FIG. 10 for the pressing of powder compacts;

FIG. 12 is a side schematic view of the pressing ends of the top punch body and the bottom punch body illustrated in FIG. 10, wherein the core pin illustrated in FIG. 11 is disposed in the top punch body, and wherein the core rod illustrated in FIG. 11 is partially disposed in the bottom punch body;

FIG. 13 is a perspective schematic view of the top punch assembly illustrated in FIG. 12;

FIG. 14 is a perspective schematic view of the bottom punch assembly illustrated in FIG. 12;

FIG. 15 is a perspective schematic view of the bottom punch assembly illustrated in FIG. 14 inserted through the bottom opening of a powder compaction mold;

FIG. 16 is a perspective schematic view of the top punch assembly illustrated in FIG. 13 inserted through the top opening of a powder compaction mold, and the bottom punch assembly illustrated in FIG. 14 inserted through the bottom opening of a powder compaction mold;

FIG. 17 is a cross-sectional schematic view of the powder pressing apparatus illustrated in FIG. 16 showing the powder compaction mold and bottom punch assembly filled with metallurgical powders to be compressed and compacted;

FIG. 18 is a cross-sectional schematic view of the powder pressing apparatus illustrated in FIG. 17 showing the compression and compaction of the metallurgical powders to make a powder compact;

FIGS. 19A and 19B are perspective and side schematic views, respectively, of the engagement of the core pin and the core rod as illustrated in FIGS. 17 and 18;

FIGS. 20A and 20B are perspective and side schematic views, respectively, of a powder compact made in the manner illustrated in FIGS. 17 and 18;

FIGS. 21A, 21B, and 21C are perspective schematic views of powder compacts made in the manner illustrated in FIGS. 4, 8, and 18 respectively;

FIG. 22 is a perspective schematic view of a bottom punch body/core rod assembly; and

FIG. 23 is a perspective schematic view of a bottom punch body/core rod assembly.

The reader will appreciate the foregoing details, as well as others, upon considering the following detailed description of various non-limiting and non-exhaustive embodiments according to this specification.

### DESCRIPTION

Various embodiments are described and illustrated in this specification to provide an overall understanding of the structure, function, operation, manufacture, and use of the disclosed processes, apparatuses, and cutting tool inserts. It is understood that the various embodiments described and illustrated in this specification are non-limiting and non-exhaustive. Thus, the invention is not necessarily limited by the description of the various non-limiting and non-exhaustive embodiments disclosed in this specification. The features and characteristics illustrated and/or described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicants reserve the right to amend the claims to affirmatively disclaim features or characteristics that may be present in the prior art. Therefore, any such amendments comply with the requirements of 35 U.S.C. §112, first paragraph, and 35 U.S.C. §132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing descriptions, definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

Spatial and directional terms such as, for example, “vertical” and “horizontal,” “above” and “below,” and “top” and “bottom,” are used in this specification. For instance, the terms “top” and “bottom” may be used with reference to the sides and/or surfaces of a cutting tool insert. It will be appreciated that these terms are used to provide a concise and clear written description of the various embodiments in connection with the figures. However, the various embodiments may be used in many orientations and positions not illustrated in the figures and, therefore, these terms are not necessarily intended to be limiting and absolute.

Cutting inserts may be manufactured using powder metallurgy techniques such as blending, pressing, and sintering of powdered metals. For instance, cemented carbide cutting inserts (e.g., comprising tungsten carbide hard particles and cobalt-based binders) may be manufactured by blending metal carbide powder and metal binder powder, pressing the blended metallurgical powders in a mold to form a powder compact in the shape of the cutting insert, and sintering the powder compact to densify the composite material into a cemented carbide cutting insert. In such production processes, the pressing of metallurgical powders into powder compacts may be a near-net-shape operation in which the geometry of the mold cavity and the pressing punches must closely match the final geometry of the cutting insert being produced. Consequently, it is important that powder compaction and pressing punches for the production of cutting inserts possess accurate and precise geometries and structural features because any structural or geometric deviations or non-uniformities may be transferred from the press tooling to the pressed powder compact and ultimately to the sintered cutting insert.

Indexable cutting tool inserts may comprise a through-hole to mechanically attach the inserts to a tool holder using a screw, for example. The through-hole may be disposed through the rake face of a single-sided cutting tool insert, or may be disposed through the top and bottom rake faces of a double-sided cutting tool insert. In this manner, the through-hole of an indexable cutting tool insert may be disposed generally parallel to the peripheral side surfaces of the insert. The peripheral side surfaces of an insert and/or the surfaces of the through-hole may connect the top surface and the bottom surface of the insert.

It is generally understood in the art that an indexable cutting tool insert may be single-sided (i.e., have one rake face) or double-sided (i.e., have two rake faces disposed on opposite top and bottom surfaces). In various embodiments, for example, the top and bottom faces of a double-sided cutting tool insert may possess mirror symmetry through a virtual middle plane. It is also generally understood in the art that the cutting edges of an indexable cutting tool insert are formed by the intersection of the rake faces and the clearance/flank faces of the insert. The clearance/flank faces of the insert are disposed on the peripheral side surfaces of the insert. For example, U.S. Pat. No. 7,976,250 discloses double-sided cutting tool inserts comprising top and bottom faces connected by peripheral side surfaces and having a through-hole disposed through the top and bottom faces and disposed generally parallel to the peripheral side surfaces of the inserts. U.S. Pat. No. 7,976,250 is incorporated by reference into this specification.

The through-hole of an indexable cutting tool insert may be countersunk so that an attachment screw used to mount the insert to a holder does not mechanically interfere with the cutting action of the insert in use. In this manner, for example, the head of an attachment screw is at least flush with the rake face through which the screw is positioned to secure the insert to a tool holder. The geometry of an indexable cutting tool insert, including the shape, size, and orientation of the rake faces, peripheral side surfaces, through-holes, and countersink features, is formed by the mechanical interaction between the constituent metallurgical powders and the surfaces of the pressing mold and the pressing punches used to form the powder compact.

Powder compacts are made by positioning a bottom punch through a bottom opening in a powder compaction mold, positioning a core rod in the powder compaction mold, filling the powder compaction mold with metallurgical powders, positioning a top punch through a top opening in the powder compaction mold, and applying compressive force to the top and/or bottom punches to compact the metallurgical powders between the opposing faces of the punches in the mold. In this manner, for example, the geometry of the faces of the top and bottom punches may form the geometry of the top and bottom faces of the powder compact, the geometry of the sidewalls of the powder compaction mold may form the geometry of the peripheral side surfaces of the powder compact, and the geometry of the core rod may form the geometry of the through-hole of the powder compact.

An issue associated with the pressing of metallurgical powders to form powder compacts for making indexable cutting tool inserts is the formation of “band” or “step” features on the surfaces of countersunk through-holes disposed through the compacts.

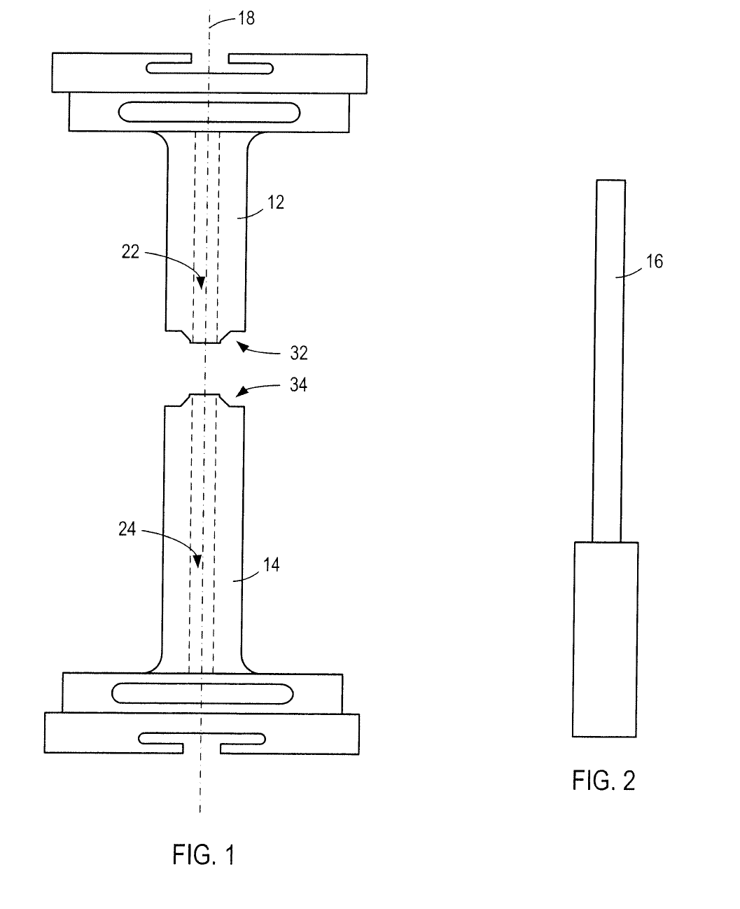

Referring to FIGS. 1-4, a powder pressing apparatus 10 for the production of cutting inserts comprises a top punch body 12, a bottom punch body 14, and a core rod 16. The core rod 16 is cylindrically-shaped. The top punch body 12 comprises an internal channel 22. The internal channel 22 is cylindrically-shaped. The top punch body 12 comprises a top punch face 32 located on the pressing end of the top punch body 12. The top punch body 12 comprises a top punch countersinking projection 42 located on the top punch face 32. The top punch countersinking projection 42 is integrally formed with the top punch body 12. The top punch countersinking projection 42 is conically-shaped and is disposed around the opening of the internal channel 22 at the top punch face 32.

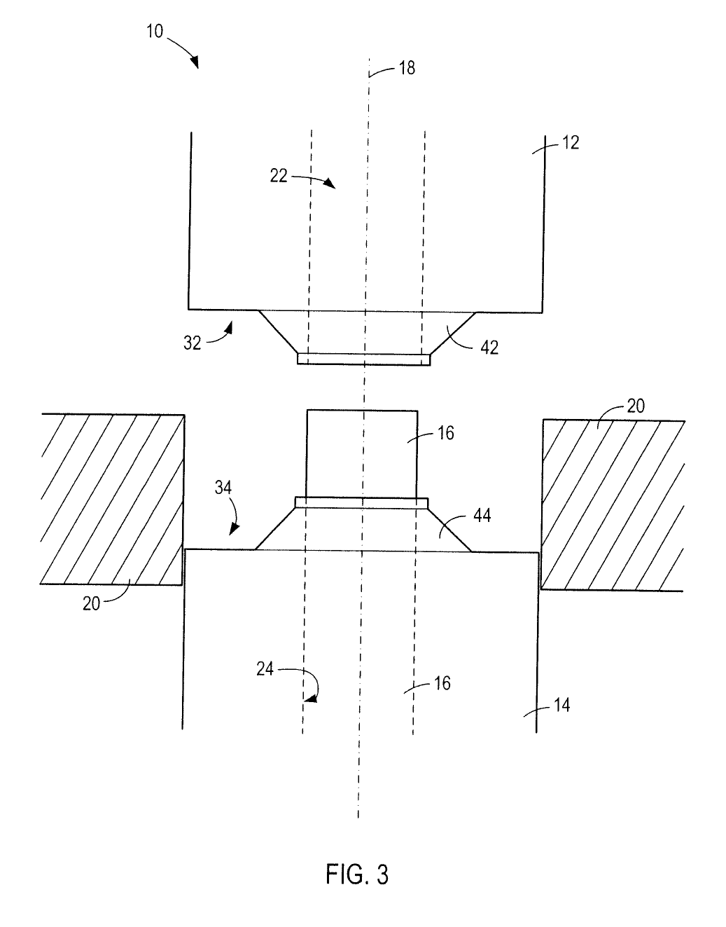

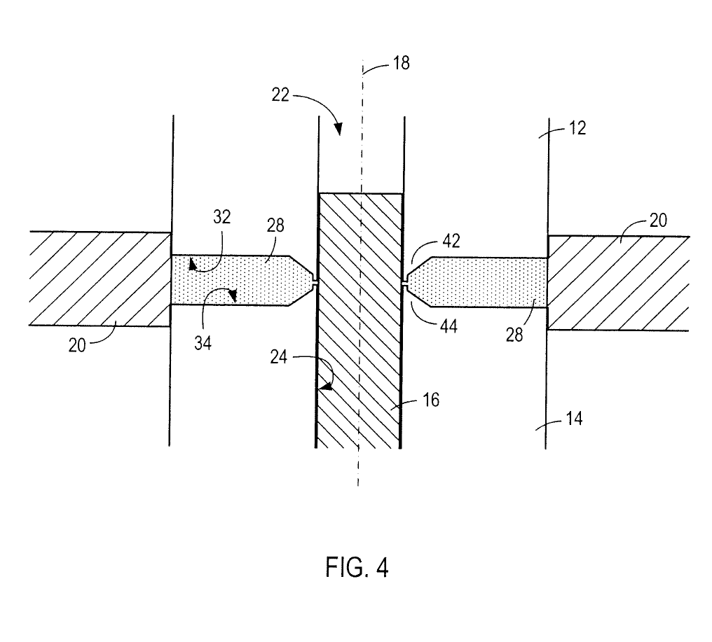

The bottom punch body 14 comprises an internal channel 24. The internal channel 24 is cylindrically-shaped and is configured to receive the core rod 16, as shown in FIG. 3. The bottom punch body 14 comprises a bottom punch face 34 located on the pressing end of the bottom punch body 14. The bottom punch body 14 comprises a bottom punch countersinking projection 44 located on the bottom punch face 34. The bottom punch countersinking projection 44 is integrally formed with the bottom punch body 14. The bottom punch countersinking projection 44 is conically-shaped and is disposed around the opening of the internal channel 24 at the bottom punch face 34.

Referring to FIG. 3, the core rod 16 is partially disposed in the internal channel 24 and is moveable relative to the bottom punch body 14 along the pressing axis 18. The core rod 16 is also moveable relative to the bottom punch countersinking projection 44, which surrounds the core rod 16 when the core rod is positioned through the opening of the internal channel 24 and partially extends above the bottom punch face 34 (see FIG. 3).

In operation, the bottom punch body 14 is positioned through a bottom opening in a powder compaction mold 20 (see FIG. 3). The core rod 16 is positioned along the pressing axis 18, through the opening of the internal channel 24, and through the bottom punch countersinking projection 44, so that the core rod 16 extends above the bottom punch face 34. In this manner, the core rod 16 is positioned partially in the internal channel 24 and partially in the powder compaction mold 20. The powder compaction mold 20, the bottom punch body 14, and the core rod 16 form an assembly comprising a mold cavity that is filled with metallurgical powders 28 to be compressed. The top punch body 12 is positioned through a top opening in the powder compaction mold 20 so that the top punch face 32 and the bottom punch face 34 are in an opposed orientation. The metallurgical powders 28 are disposed between the opposed top punch face 32 and the bottom punch face 34 (see FIG. 4).

The top punch body 12 is moved along the pressing axis 18 toward the bottom punch body 14 in the powder compaction mold 20. Compressive force is applied to the metallurgical powders 28 through the top punch face 32 of the top punch body 12 and the bottom punch face 34 of the bottom punch body 14. As the top punch body 12 moves toward the bottom punch body 14, the core rod 16 is held stationary in order to form a through-hole in the resulting powder compact. As the top punch body 12 moves toward the bottom punch body 14 to compress the metallurgical powders 28, the stationary core rod 16 enters into the internal channel 22 in the top punch body 12 through the opening in the top punch face 32. The stationary core rod 16 also enters into the internal channel 22 through the top punch countersinking projection 42. The core rod 16 is positioned partially in the internal channel 24 in the bottom punch body 14 and partially in the internal channel 22 in the top punch body 12 (see FIG. 4). In this manner, the internal channel 22 in the top punch body 12 functions as a clearance channel for the stationary core rod 16 during a pressing stroke.

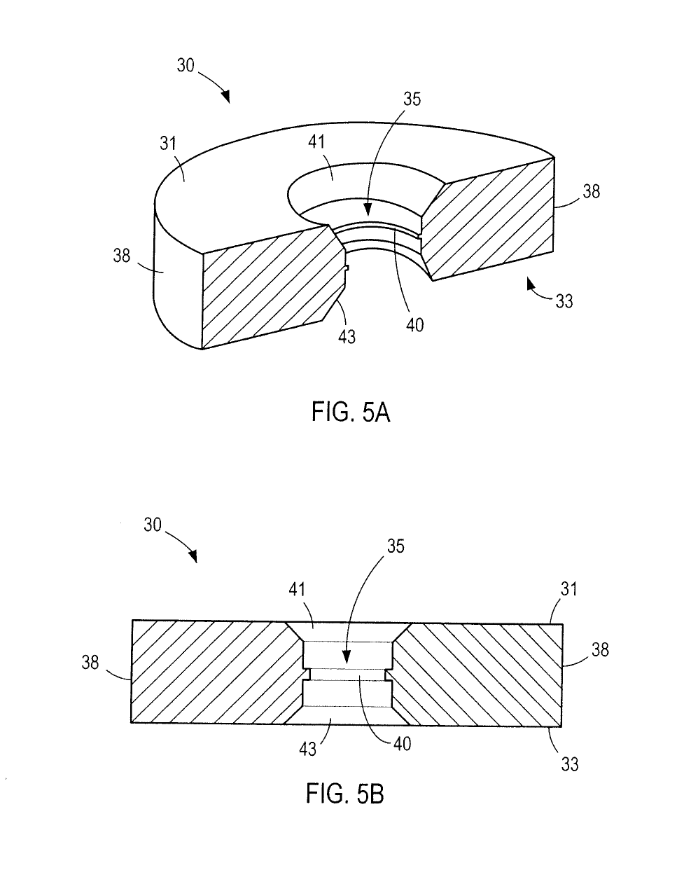

The metallurgical powders 28 are compressed and compacted between the top punch face 32, the bottom punch face 34, the sidewalls of the powder compaction mold 20, and the core rod 16 during a pressing stroke, as shown in FIG. 4. FIGS. 5A and 5B show the resulting powder compact 30. The powder compact 30 comprises a top surface 31, a bottom surface 33, and a peripheral side surface 38. A through-hole 35 is disposed through the top and bottom surfaces 31 and 33, and is disposed generally parallel to the peripheral side surface 38. The through-hole 35 comprises a top countersunk surface 41 and a bottom countersunk surface 43. The powder compact 30 is for the production of a double-sided indexable cutting tool insert, which would be attached to a tool holder using a correspondingly countersunk screw positioned in the through-hole 35. In this manner, the resulting cutting tool insert can be attached to a tool holder so that either the top surface 31 or the bottom surface 33 may be outwardly facing from the tool holder at any one time.

The geometries of the top and bottom surfaces 31 and 33 of the powder compact 30 are respectively formed by the geometries of the top punch face 32 and the bottom punch face 34. The geometry of the peripheral side surface 38 is formed by the geometry of the sidewall of the powder compaction mold 20. The geometries of the top and bottom countersunk surfaces 41 and 43 are respectively formed by the geometries of the top punch countersinking projection 42 and the bottom punch countersinking projection 44.

The through-hole 35 also comprises a “band” region 40. The band region 40 forms on the surface of the through-hole located between the top and bottom countersunk surfaces 41 and 43, which is where the metallurgical powder 28 is compressed between the end of the top punch countersinking projection 42 and the end of the bottom punch countersinking projection 44, as shown in FIG. 4. The band region 40 is located at the center plane of the powder compact 30 along the thickness dimension of the powder compact.

In various embodiments, band regions may be problematic. For example, band regions may cause mechanical interference with attachment screws used to mount cutting tool inserts to tool holders. Also, band regions may require the formation of thicker powder compacts and resulting cutting tool inserts, which limits design flexibility and requires the use of more metallurgical powder material. In addition, band regions may be prone to cracking and breakage before the powder compacts are sintered, which may require that an entire powder compact be scrapped. Furthermore, band regions may increase the incidence of breakage of the pressing punches because the pressing pressure maximizes at the center of the pressing plane, which corresponds to the center plane of the compact in the thickness dimension where the band regions are located. In certain circumstances, the size of the band region may be reduced or minimized by reducing or minimizing the size of the through-hole-forming wall section on the top and/or bottom punches. However, reducing or minimizing the size of this section of the punches may significantly weaken the punches, which may then be easily damaged by pressing forces or even mishandling of the punches.

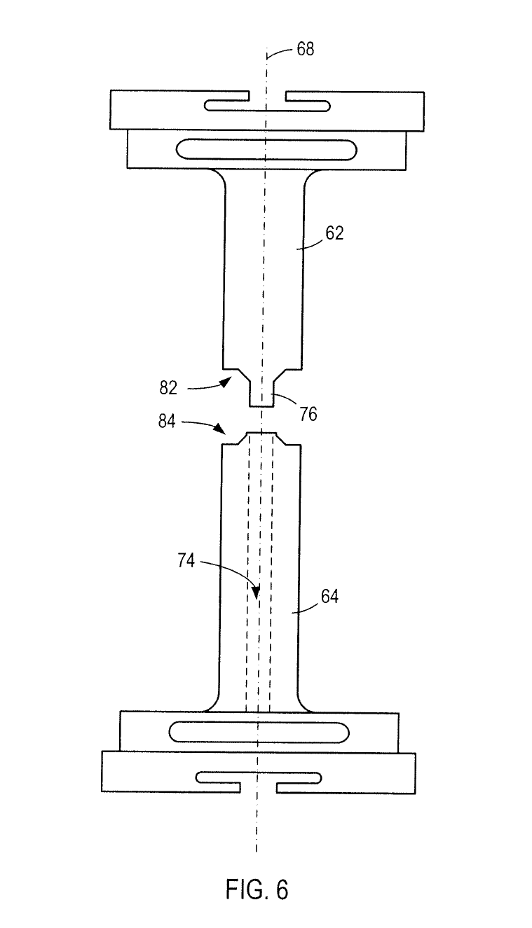

Referring to FIGS. 6-8, a powder pressing apparatus 60 for the production of cutting inserts comprises a top punch body 62, a bottom punch body 64, and a core rod 66. The core rod 66 is cylindrically-shaped. The top punch body 62 comprises a top punch face 82 located on the pressing end of the top punch body 62. The top punch body 62 comprises a top punch countersinking projection 92 located on the top punch face 82. The top punch countersinking projection 92 is integrally formed with the top punch body 62. The top punch body 62 also comprises a core pin projection 76. The core pin projection 76 is cylindrically-shaped. The core pin projection 76 is integrally formed with the top punch countersinking projection 92 and the top punch body 62. The top punch countersinking projection 92 is conically-shaped and integral with the cylindrically-shaped core pin projection 76 at the base of the core pin projection 76 where the core pin projection meets the top punch face 82.

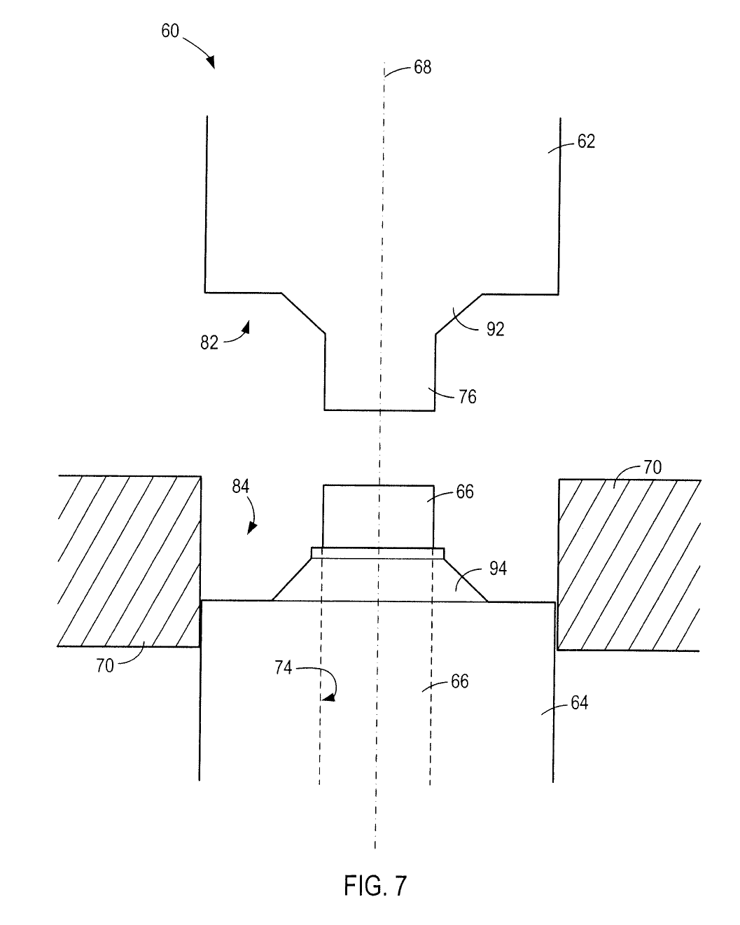

The bottom punch body 64 comprises an internal channel 74. The internal channel 74 is cylindrically-shaped and is configured to receive the core rod 66, as shown in FIG. 7. The bottom punch body 64 comprises a bottom punch face 84 located on the pressing end of the bottom punch body 64. The bottom punch body 64 comprises a bottom punch countersinking projection 94 located on the bottom punch face 84. The bottom punch countersinking projection 94 is integrally formed with the bottom punch body 64. The bottom punch countersinking projection 94 is conically-shaped and surrounds the opening of the internal channel 74 at the bottom punch face 84.

Referring to FIG. 7, the core rod 66 is partially disposed in the internal channel 74 and is moveable relative to the bottom punch body 64 along the pressing axis 68. The core rod 66 is also moveable relative to the bottom punch countersinking projection 94, which surrounds the core rod 66 when the core rod is partially positioned through the opening of the internal channel 74 and extends above the bottom punch face 84 (see FIG. 7).

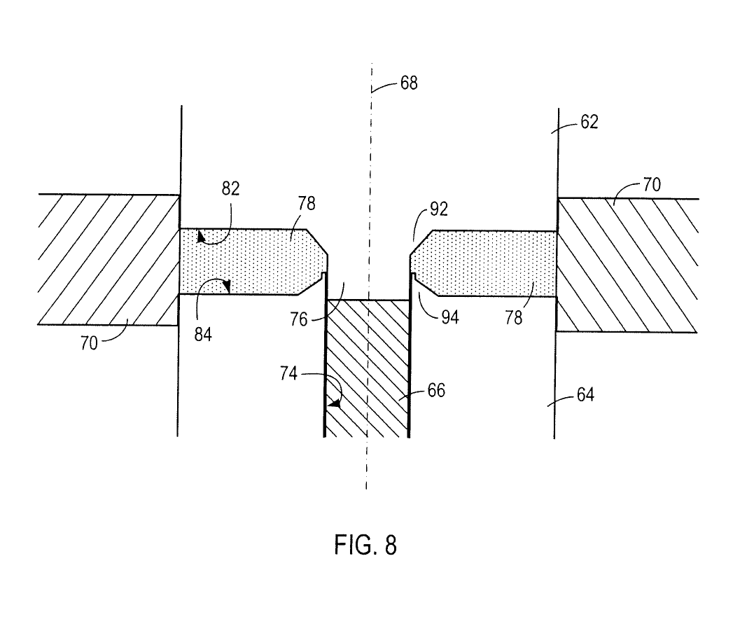

In operation, the bottom punch body 64 is positioned through a bottom opening in a powder compaction mold 70 (see FIG. 7). The core rod 66 is positioned along the pressing axis 68, through the opening of the internal channel 74, and through the bottom punch countersinking projection 94, so that the core rod 66 extends above the bottom punch face 84. In this manner, the core rod 66 is positioned partially in the internal channel 74 and partially in the powder compaction mold 70. The powder compaction mold 70, the bottom punch body 64, and the core rod 66 form an assembly comprising a mold cavity that is filled with metallurgical powders 78 to be compressed. The top punch body 62 is positioned through a top opening in the powder compaction mold 70 so that the top punch face 82 and the bottom punch face 84 are in an opposed orientation. The metallurgical powders 78 are disposed between the opposed top punch face 82 and the bottom punch face 84 (see FIG. 8).

The top punch body 62 is moved along the pressing axis 68 toward the bottom punch body 64 in the powder compaction mold 70. Compressive force is applied to the metallurgical powders 78 through the top punch face 82 of the top punch body 62 and the bottom punch face 84 of the bottom punch body 64. As the top punch body 62 moves toward the bottom punch body 64, the core pin projection 76 co-axially engages the core rod 66 and pushes the core rod 66 fully into the internal channel 74 in the bottom punch body 64 (see FIG. 8). The co-axial engagement of the core pin projection 76 and the core rod 66 maintains a through-hole in the resulting powder compact. As the top punch body 62 moves toward the bottom punch body 64 to compress the metallurgical powders 78, the core pin projection 76 enters into the internal channel 74 in the bottom punch body 64 through the opening in the bottom punch face 84 through which the core rod 66 was partially extended (as shown in FIG. 7) before being pushed fully into the internal channel 74 by the engaging and advancing core pin projection 76 (as shown in FIG. 8). In this manner, the core rod 66 is positioned fully in the internal channel 74 in the bottom punch body 64 and the core pin projection is positioned partially in the internal channel 74 in the bottom punch body 64 and partially forms the surfaces of the through-hole in the resulting powder compact (see FIG. 8).

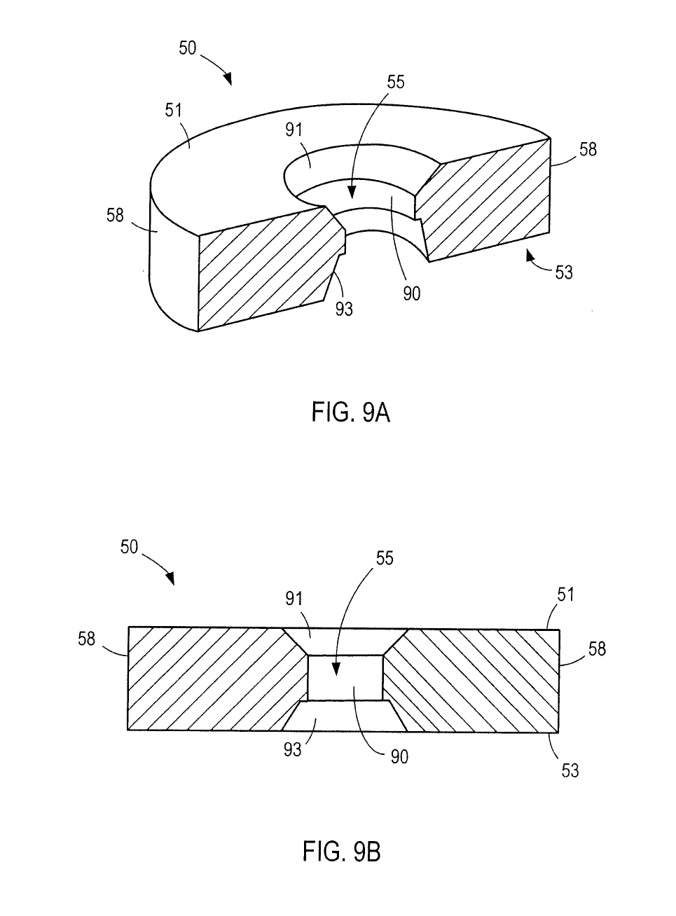

The metallurgical powders 78 are compressed and compacted between the top punch face 82, the bottom punch face 84, the sidewalls of the powder compaction mold 70, and the core pin projection 76 during a pressing stroke, as shown in FIG. 8. FIGS. 9A and 9B show the resulting powder compact 50. The powder compact 50 comprises a top surface 51, a bottom surface 53, and a peripheral side surface 58. A through-hole 55 is disposed through the top and bottom surfaces 51 and 53, and is disposed generally parallel to the peripheral side surface 58. The through-hole 55 comprises a top countersunk surface 91 and a bottom countersunk surface 93. The powder compact 50 is for the production of a double-sided indexable cutting tool insert, which would be attached to a tool holder using a correspondingly countersunk screw positioned in the through-hole 55. In this manner, the resulting cutting tool insert can be attached to a tool holder so that either the top surface 51 or the bottom surface 53 may be outwardly facing from the tool holder at any one time.

The geometry of the top and bottom surfaces 51 and 53 of the powder compact 50 are respectively formed by the geometries of the top punch face 82 and the bottom punch face 84. The geometry of the peripheral side surface 58 is formed by the geometry of the sidewall of the powder compaction mold 70. The geometries of the top and bottom countersunk surfaces 91 and 93 are respectively formed by the geometries of the top punch countersinking projection 92 and the bottom punch countersinking projection 94.

The integral core pin projection 76 eliminates any band regions, but the through-hole 55 still comprises a “step” region 90. The step region 90 forms on the surface of the through-hole located between the top and bottom countersunk surfaces 91 and 93, which is where the metallurgical powder 78 is compressed between the top punch countersinking projection 92 and the end of the bottom punch countersinking projection 94. The step region 90 is disposed at the center of the thickness dimension of the powder compact 50.

In various embodiments, step regions may be problematic for the same reasons that band regions may be problematic, as described above. More generally, any regions or features on the surface of a through-hole that provide a discontiguity between the countersunk regions of the through-hole may cause mechanical interference with attachment screws used to mount cutting tool inserts to tool holders. Also, discontiguous regions such as bands or steps in a through-hole require the formation of thicker powder compacts and resulting cutting inserts, which limits design flexibility and requires the use of more metallurgical powder material. In addition, discontiguous regions may be prone to cracking and breakage before the powder compacts are sintered, which may require that an entire compact be scrapped. Furthermore, discontiguous regions such as bands or steps in a through-hole may increase the incidence of breakage of the pressing punches.

In various embodiments, two-sided cutting tool inserts comprise a top surface, a bottom surface, and a countersunk through-hole connecting the top surface and the bottom surface, wherein the countersunk through-hole comprises a contiguous through-hole surface connecting the top surface and the bottom surface. As used herein, the term “contiguous surface” or “contiguous through-hole surface” refers to a surface lacking bands, steps, planar intersections, or other geometrical surface discontiguities. Two-sided cutting tool inserts comprising contiguous through-hole surfaces may be made, for example, using a powder pressing apparatus comprising a core pin and a core rod, wherein the core pin and the core rod both comprise countersinking projections comprising the same projection geometry.

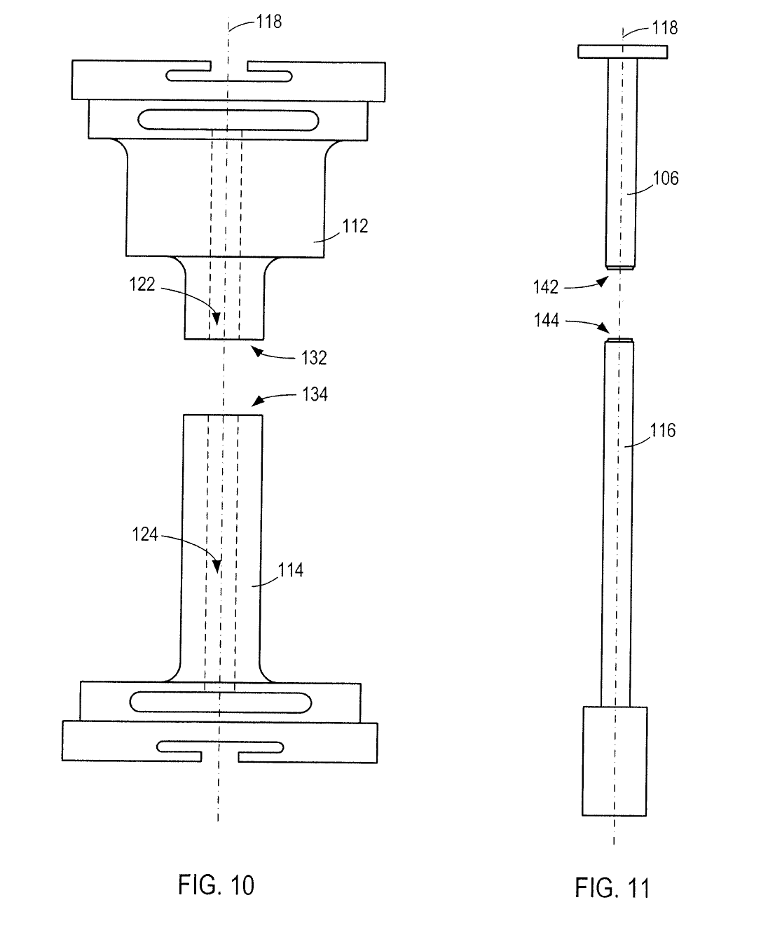

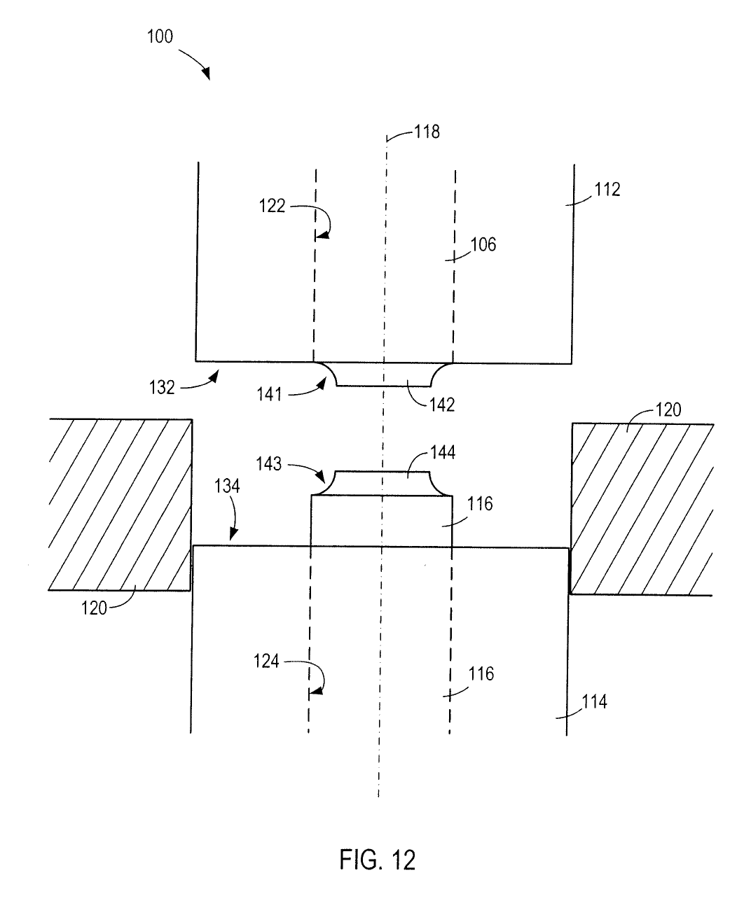

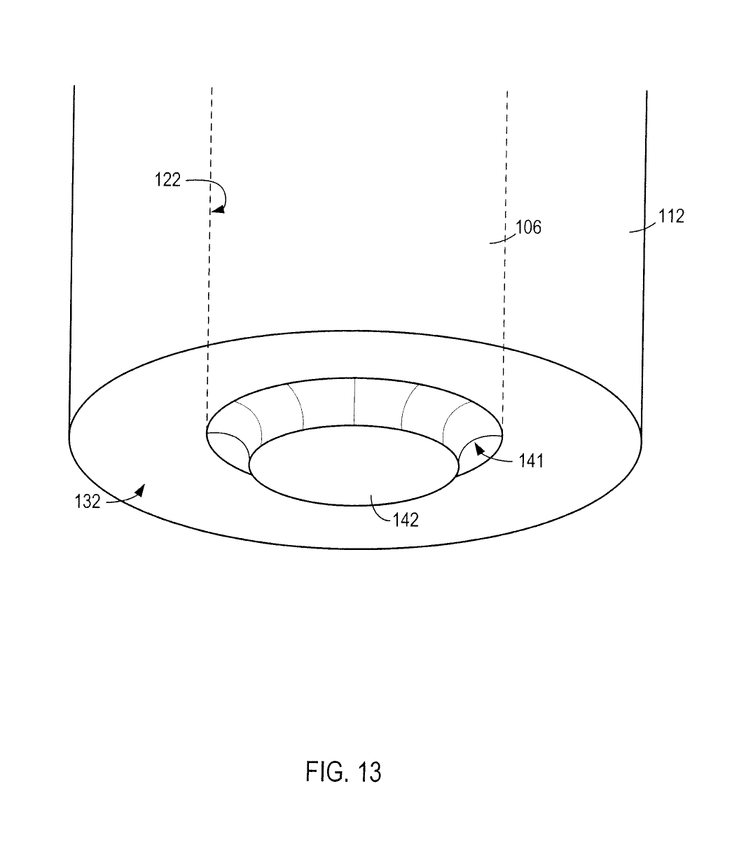

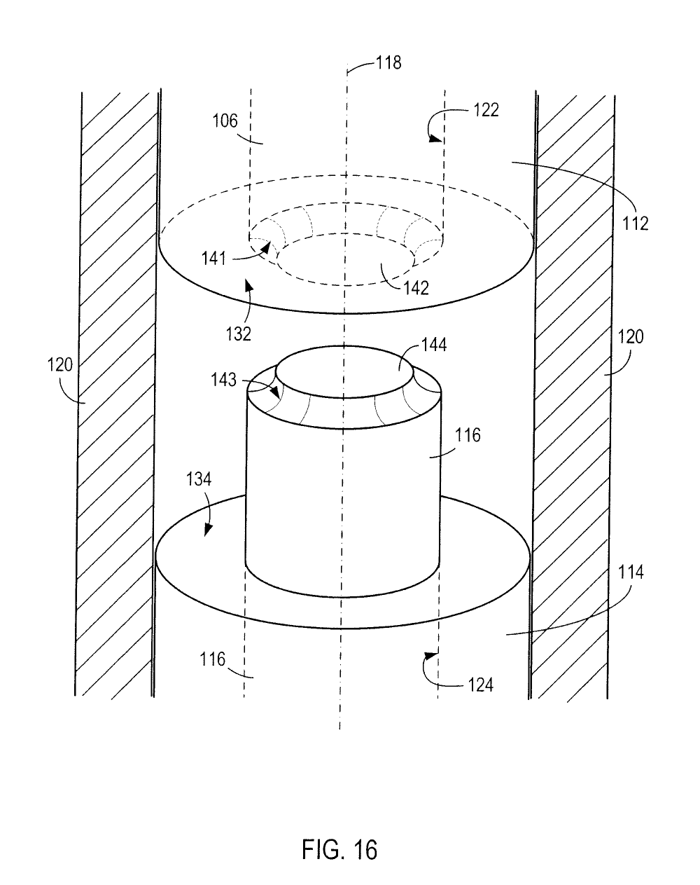

Referring to FIGS. 10-18, a powder pressing apparatus 100 for the production of cutting inserts comprises a top punch body 112, a bottom punch body 114, a core pin 106, and a core rod 116. The core pin 106 and the core rod 116 are cylindrically-shaped. The top punch body 112 comprises an internal channel 122. The internal channel 122 is cylindrically-shaped and is configured to receive the core pin 106, as shown in FIGS. 12, 13, and 16-18. The top punch body 112 comprises a top punch face 132 located on the pressing end of the top punch body 112. The core pin 106 comprises a core pin countersinking projection 142 located on the pressing end of the core pin 106. The core pin countersinking projection 142 is integrally formed with the core pin 106. The core pin countersinking projection 142 comprises an arcuately-shaped projection surface 141, which is disposed around the circumference of the cylindrical core pin 106 at the pressing end of the core pin, as shown in FIGS. 13 and 16. The top punch body 112 and the core pin 106 collectively comprise a top punch assembly.

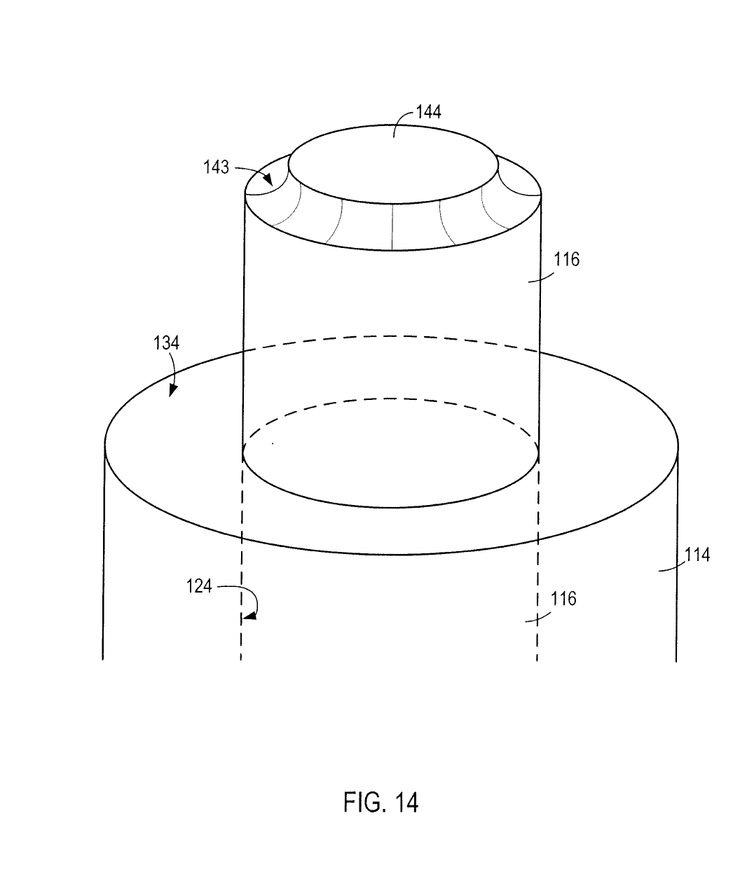

The bottom punch body 114 comprises an internal channel 124. The internal channel 124 is cylindrically-shaped and is configured to receive the core rod 116, as shown in FIGS. 12 and 14-18. The bottom punch body 114 comprises a bottom punch face 134 located on the pressing end of the bottom punch body 114. The core rod 116 comprises a core rod countersinking projection 144 located on the pressing end of the core rod 116. The core rod countersinking projection 144 is integrally formed with the core rod 116. The core rod countersinking projection 144 comprises an arcuately-shaped projection surface 143, which is disposed around the circumference of the cylindrical core rod 116 at the pressing end of the core rod, as shown in FIGS. 14-16. The bottom punch body 114 and the core rod 116 collectively comprise a bottom punch assembly.

Referring to FIGS. 12, 13, 16, and 17, the core pin 106 is disposed in the internal channel 122 and is movable relative to the top punch body 112 along the pressing axis 118. In various embodiments, the core pin 106 and the top punch body 112 may be structured so that when the core pin 106 is disposed in the internal channel 112, only the core pin countersinking projection 142 extends beyond the top punch face 132. Referring to FIGS. 12 and 14-17, the core rod 116 is partially disposed in the internal channel 124 and is movable relative to the bottom punch body 114 along the pressing axis 118. The core rod 116 is also partially disposed through the opening of the internal channel 124 and partially extends above the bottom punch face 134. In various embodiments, the core rod 116 and the bottom punch body 114 may be structured so that the position of the core rod 116 within the internal channel 124 (and the portion of the core rod extending through the opening of the internal channel 124) is adjustable relative to the bottom punch body 114.

The core rod countersinking projection 144 and the core pin countersinking projection 142 each comprise the same geometry. The top and bottom punch bodies 112 and 114 lack any projections on the faces 132 and 134 at the pressing ends of the punch bodies.

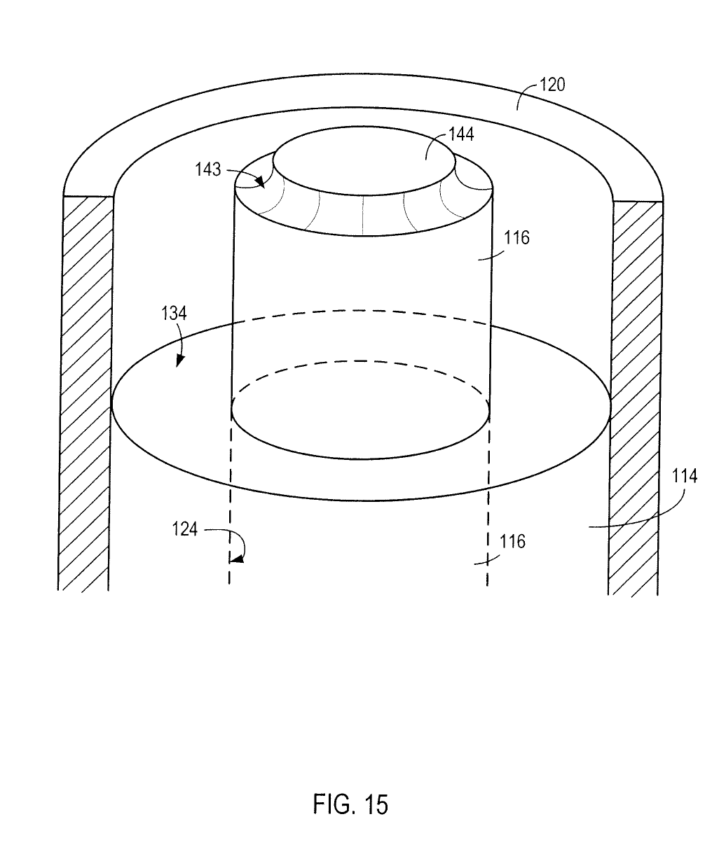

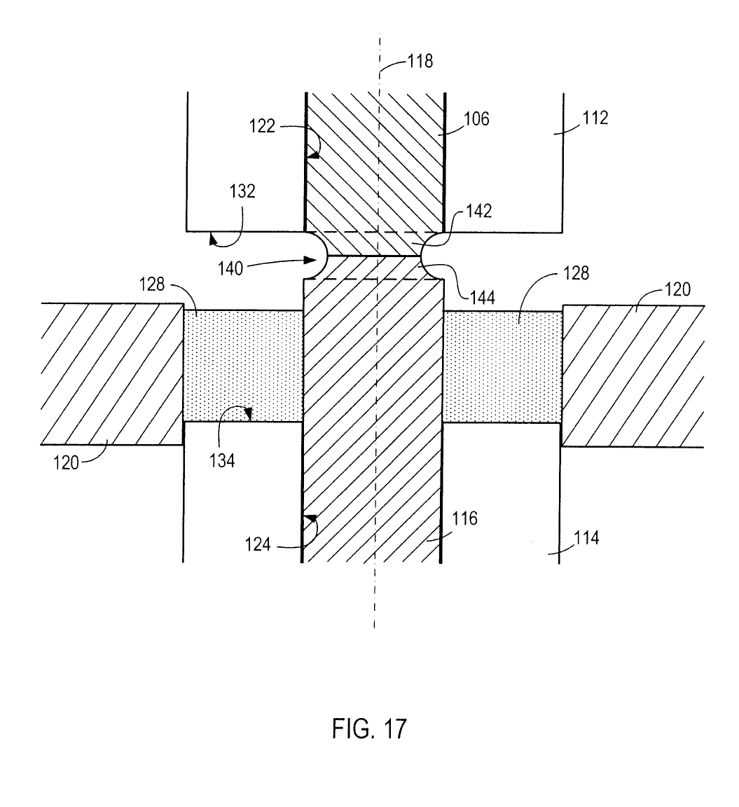

In operation, the bottom punch body 114 is positioned through a bottom opening in a powder compaction mold 120 (see FIGS. 12 and 15). The core rod 116 is positioned along the pressing axis 118, through the opening of the internal channel 124 at the bottom punch face 134, so that the core rod 116 extends above the bottom punch face 134 (see FIGS. 14 and 15). In this manner, the core rod 116 is positioned partially in the internal channel 124 and partially in the powder compaction mold 120. The powder compaction mold 120, the bottom punch body 114, and the core rod 116 form an assembly comprising a mold cavity that is filled with metallurgical powders 128 to be compressed (see FIG. 17).

The top punch body 112 is positioned through a top opening in the powder compaction mold 120 so that the top punch face 132 and the bottom punch face 134 are in an opposed orientation (see FIGS. 12 and 16). The core pin 106 is positioned in the top punch body 112 so that only the core pin countersinking projection 142 (and the core pin countersinking projection surface 141) extends below the top punch face 132 (see FIGS. 12, 13, and 17). The metallurgical powders 128 are disposed between the opposed top and bottom punch faces 132 and 134 (see FIG. 17). During a pressing operation, the core pin 106 is held stationary and in a fixed position relative to the top punch body 112 (and, therefore, also relative to the top punch face 132) and moves with the top punch body 112 while maintaining the fixed position relative to the top punch body.

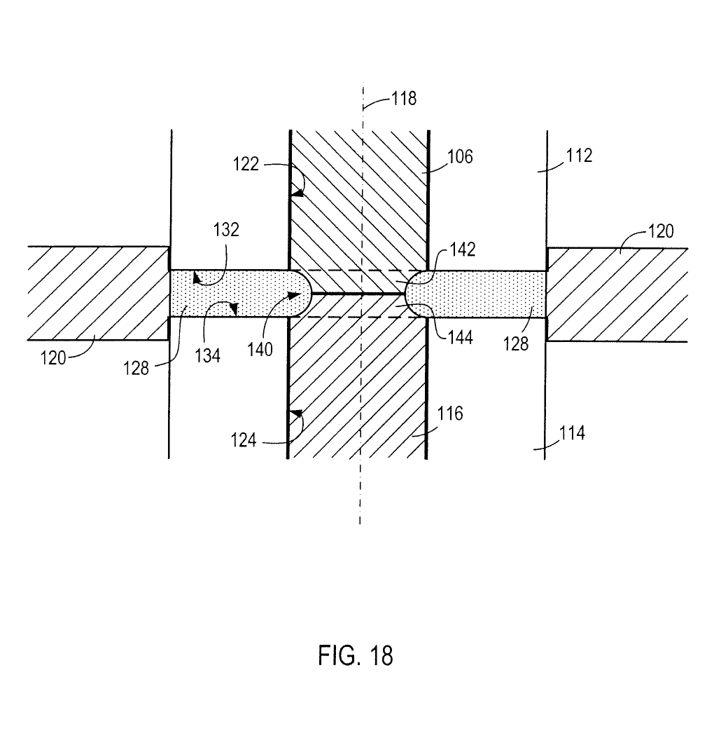

The top punch body 112 is moved along the pressing axis 118 toward the bottom punch body 114 in the powder compaction mold 120. The core pin 106, which is held in fixed position relative to the top punch body 112 during a press stroke, only moves with the movement of the top punch body 112 along the pressing axis 118 during the press stroke. Compressive force is applied to the metallurgical powders 128 through the top punch face 132 of the top punch body 112 and through the bottom punch face 134 of the bottom punch body 114. As the top punch body 112 moves toward the bottom punch body 114, the core pin 106 and the core pin countersinking projection 142 are co-axially aligned with and co-axially engage the core rod 116 and the core rod countersinking projection 144 (see FIG. 17). The core pin 106 is held stationary and in position relative to the top punch body 112 in order to form a through-hole in the resulting powder compact. The core pin 106 engages with the core rod 116 and the core rod 116 moves along the pressing axis 118 into the internal channel 124 in the bottom punch body 114 until only the core rod countersinking projection 144 extends above the bottom punch face 134 (see FIG. 18).

The core rod 116 may be biased in the advanced position extending above the bottom punch face 134, as shown in FIGS. 12 and 14-17, using a mechanical biasing mechanism such as a core rod positioning spring (not shown), which provides a floating core rod 116 extending from the bottom punch body 114. In such embodiments, the engagement of the core pin 106 with the core rod 116 overcomes the biasing force to push the core rod 116 into the internal channel 124 in the bottom punch body 114 until only the core rod countersinking projection 144 extends above the bottom punch face 134, as shown in FIG. 18. In other embodiments, the movement of the core rod 116 along the pressing axis 118 in the internal channel 124 in the bottom punch body 114 may be actuated using a pneumatic, hydraulic, or robotic mechanism that is controlled simultaneously with the movement of the top punch body 112 toward the bottom punch body 114 to compress and compact the metallurgical powders 128. In such embodiments, pneumatic, hydraulic, or robotic actuation may be programmable and controlled using computer numerical control (CNC) methods, for example.

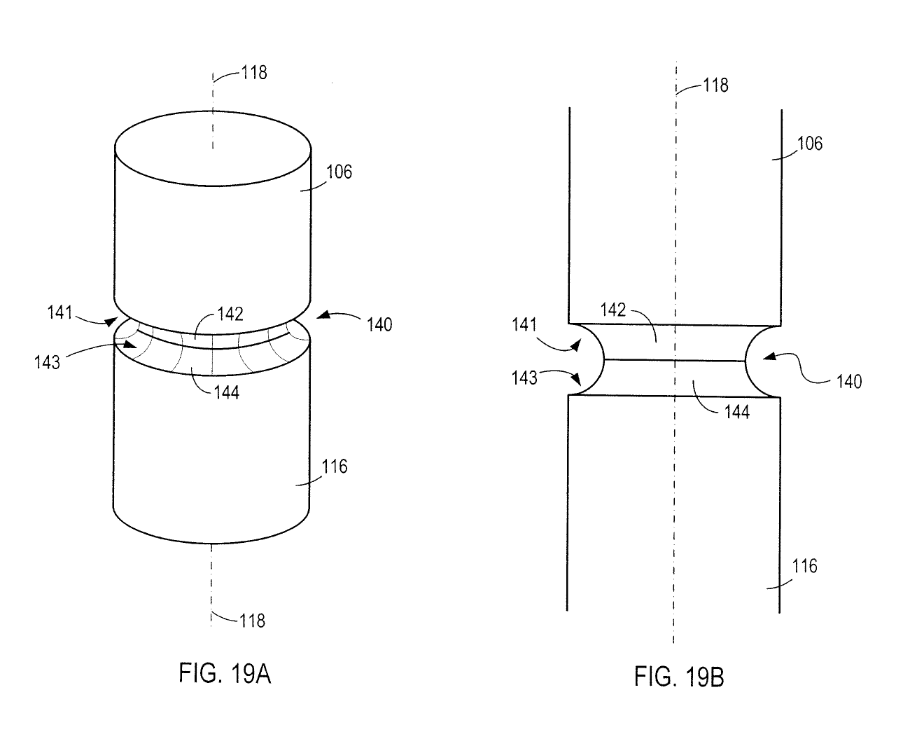

The co-axial engagement of the core pin countersinking projection 142 and the core rod countersinking projection 144 maintains a through-hole in the resulting powder compact. When the core pin countersinking projection 142 and the core rod countersinking projection 144 are engaged, as shown in FIGS. 17-19B, the arcuately-shaped core pin countersinking projection surface 141 and the arcuately-shaped core rod countersinking projection surface 143 together form a through-hole contouring surface 140. Referring to FIG. 18, when the top and bottom punch bodies 112 and 144 fully compress the metallurgical powders 128 at the end of a press stroke, the through-hole contouring surface 140 is located completely in the powder compaction mold 120 between the bottom punch face 134 and the top punch face 132 along the pressing axis 118. The core pin countersinking projection 142 and the core rod countersinking projection 144 (and the respective countersinking projection surfaces 141 and 143) extend below and above the top punch face 132 and the bottom punch face 134, respectively. The core pin countersinking projection 142 is engaging the core rod countersinking projection 144 at the center plane of the resulting powder compact along the pressing axis, which is parallel to the thickness dimension of the compact. In this manner, the top half of the through-hole surface of the resulting powder compact (along the pressing axis/thickness dimension) is formed by the core pin countersinking projection 142, and the bottom half of the through-hole surface of the resulting powder compact is formed by the core rod countersinking projection 144. The countersinking projection surfaces 141 and 143 of the mutually-engaging the core pin 106 and core rod 116 together form a contiguous through-hole contouring surface 140 comprising a three-dimensional toroidal shape (i.e., having the three-dimensional contour of a geometric toroid), as shown in FIG. 19A. The contiguous through-hole contouring surface 140 comprises a contiguous arcuate profile when viewed in cross section, as shown in FIG. 19B

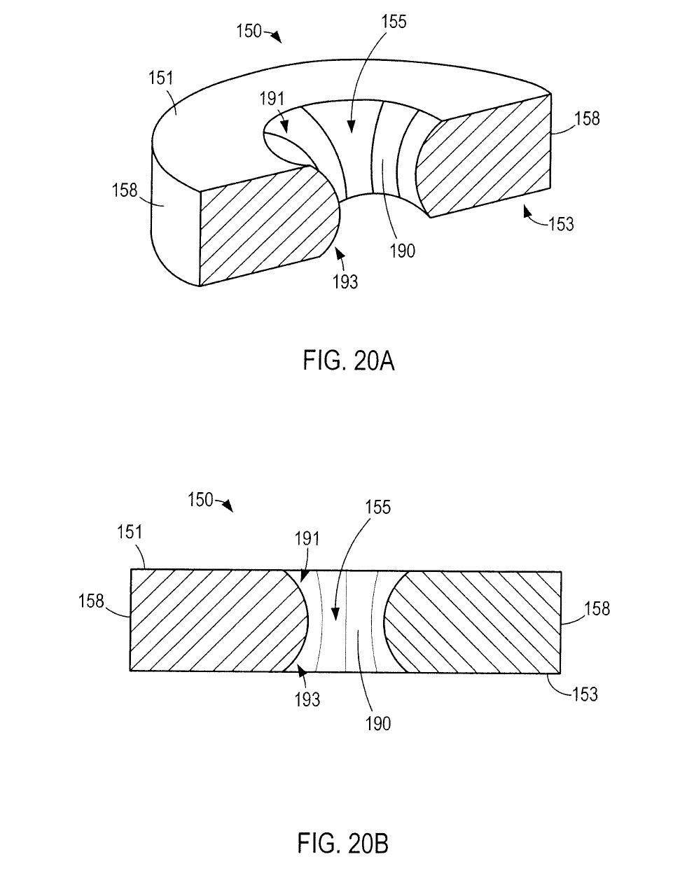

The metallurgical powders 128 are compressed and compacted between the top punch face 132, the bottom punch face 134, the sidewall of the powder compaction mold 120, and the through-hole contouring surface 140. FIGS. 20A and 20B show the resulting powder compact 150. The powder compact 150 comprises a top surface 151, a bottom surface 153, and a peripheral side surface 158. A through-hole 155 is disposed through the top and bottom surfaces 151 and 153, and is disposed generally parallel to the peripheral side surface 158. The through-hole 155 comprises a contiguous surface 190 connecting the top surface 151 and the bottom surface 153. As shown in FIGS. 20A and 20B, the contiguous through-hole surface 190 lacks bands, steps, or other geometrical discontiguities. The through-hole 155 comprises a top countersunk region 191 and a bottom countersunk region 193. The top countersunk region 191 and the bottom countersunk region 193 are regions of the contiguous through-hole surface 190. The contiguous through-hole surface 190 comprises a three-dimensional toroidal surface (i.e., having the three-dimensional contour of a geometric toroid), as shown in FIG. 20A. The contiguous through-hole surface 190 comprises a contiguous arcuate profile when viewed in cross section, as shown in FIG. 20B.

The geometries of the top and bottom surfaces 151 and 153 of the powder compact 150 are respectively formed by the geometries of the top punch face 132 and the bottom punch face 134. The geometry of the peripheral side surface 158 is formed by the geometry of the sidewall of the powder compaction mold 120. Referring to FIGS. 19A and 19B in connection with FIG. 20A and 20B, the geometries of the top and bottom countersunk regions 191 and 193 are respectively formed by the geometries of the core pin countersinking projection surface 141 and the core rod countersinking projection surface 143. In this manner, the geometry of the contiguous through-hole surface 190 is formed by the geometry of the contiguous through-hole contouring surface 140.

The powder compact 150 is for the production of a double-sided indexable cutting tool insert, which would be attached to a tool holder using a correspondingly countersunk screw positioned in the through-hole 155. In this manner, the resulting cutting tool insert can be attached to a tool holder so that either the top surface 151 or the bottom surface 153 may be outwardly facing from the tool holder at any one time.

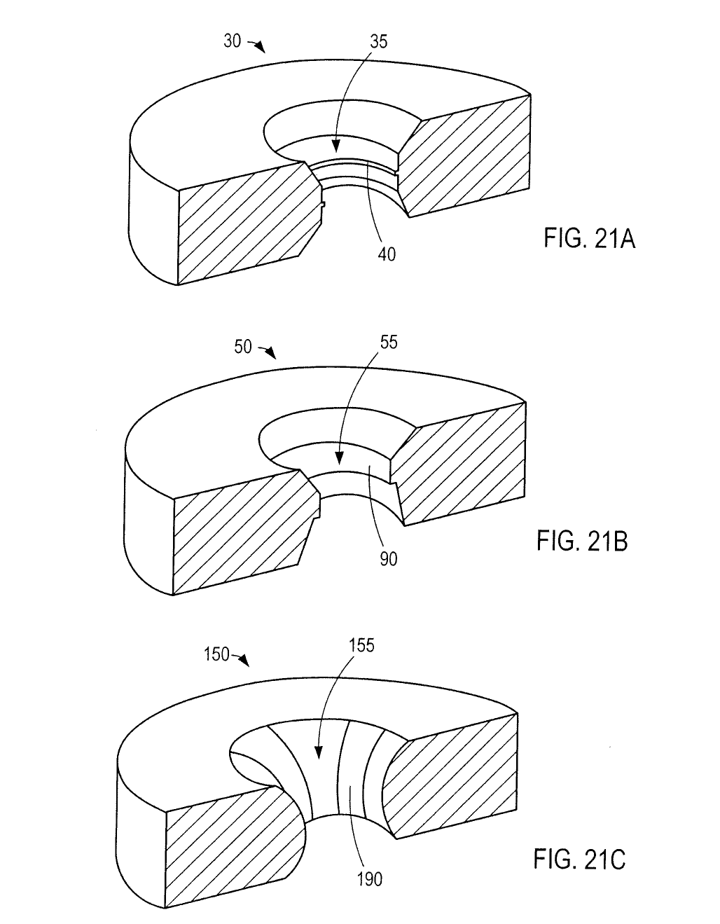

FIGS. 21A-21C compare powder compacts 30, 50, and 150, respectively comprising a discontiguous band region 40, a discontiguous step region 90, and a contiguous through-hole surface 190. The powder compacts 30, 50, and 150 may be used to make double-sided cutting tool inserts. As shown in FIGS. 21A-21C, the use of a core pin and core rod each comprising opposed countersinking projections having the same arcuate geometry, along with the use of punch bodies lacking countersinking projections on the pressing ends, will produce powder compacts lacking potentially problematic discontiguities along the surfaces of the through-holes.

Contiguous through-hole surfaces reduce the potential for mechanical interference with attachment screws used to mount cutting tool inserts to tool holders as compared to through-holes comprising discontiguous surfaces. In addition, contiguous through-hole surfaces allow for the production of thinner powder compacts and resulting cutting inserts, which increases design flexibility and requires the use of less metallurgical powder material. In addition, the contiguous through-hole surfaces reduce the likelihood of green cracking and breakage before sintering as compared to compacts comprising bands, steps, or other surface discontiguities. Furthermore, contiguous through-hole surfaces may decrease the incidence of breakage of pressing punches during a pressing operation because the use of a core pin and core rod each comprising opposed counter-sinking projections having the same arcuate geometry reduces the pressing pressure inside the through-hole during a press stroke. Further still, contiguous through-hole surfaces provide for a stronger and more robust cutting tool insert.

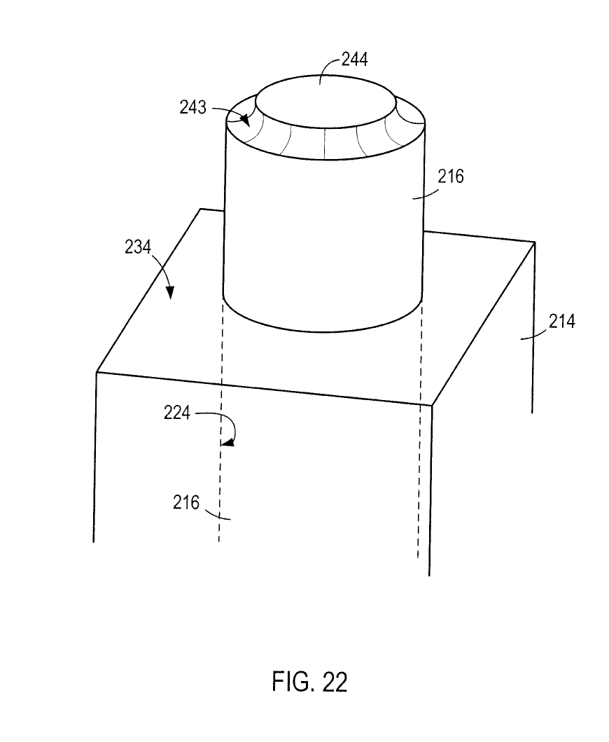

The embodiments illustrated in FIGS. 1-21C employ powder pressing punches and powder compaction molds that form round-shaped powder compacts, which would be sintered to produce round-shaped cutting tool inserts. However, it is understood that the various embodiments described in this specification are not limited to round-shaped powder compacts and cutting tool inserts. Instead, the various embodiments described in this specification may be used to produce powder compacts and cutting tool inserts having any peripheral shape including, for example, round, triangular, trigonal, square, rectangular, parallelogram, pentagonal, hexagonal, octagonal, asymmetrical shapes, and the like. For instance, FIG. 22 shows a bottom punch body 214 comprising a square peripheral shape which may be used to produce powder compacts (and cutting tool inserts) having a correspondingly square peripheral shape. The bottom punch body 214 comprises a bottom punch face 234 and an internal channel 224. A core rod 216 comprising a core rod countersinking projection 224 is positioned in the internal channel 224 in the bottom punch body 214. The core rod countersinking projection 224 comprises an arcuately-shaped countersinking projection surface 243. The core rod 216 and the bottom punch body 214 may be used with correspondingly shaped and sized powder compaction molds, top punch bodies, and core pins to produce square-shaped powder compacts and cutting tool inserts having contiguous through-hole surfaces, as generally described in this specification.

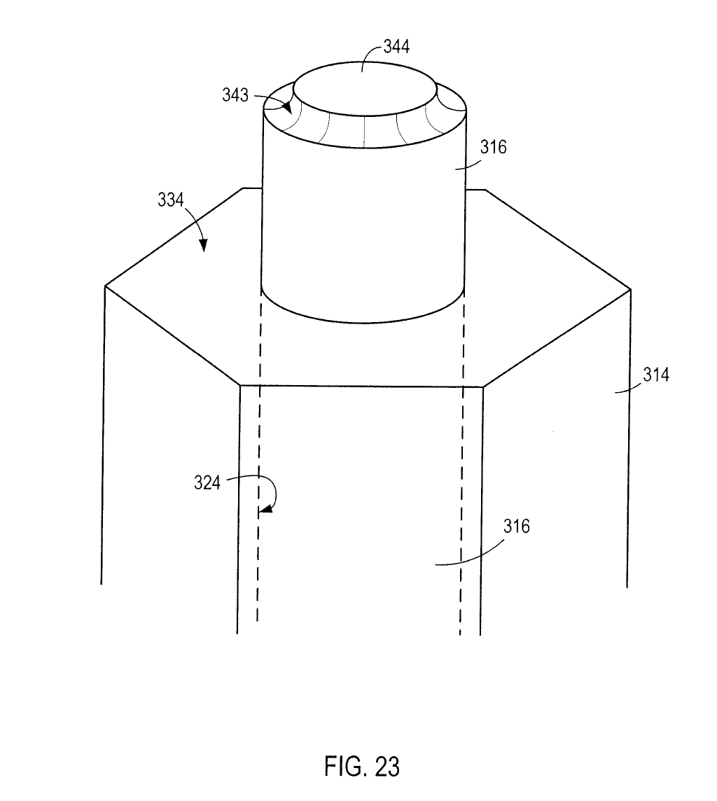

FIG. 23 shows a bottom punch body 314 comprising a hexagonal peripheral shape which may be used to produce powder compacts (and cutting tool inserts) having a correspondingly hexagonal peripheral shape. The bottom punch body 314 comprises a bottom punch face 334 and an internal channel 324. A core rod 316 comprising a core rod countersinking projection 324 is positioned in the internal channel 324 in the bottom punch body 314. The core rod countersinking projection comprises an arcuately-shaped countersinking projection surface 243. The core rod 316 and the bottom punch body 314 may be used with correspondingly shaped and sized powder compaction molds, top punch bodies, and core pins to produce hexagonal-shaped powder compacts and cutting tool inserts having contiguous through-hole surfaces, as generally described in this specification. In like manner, powder compaction molds, top punch bodies, and bottom punch bodies having triangular, trigonal, rectangular, parallelogram, pentagonal, octagonal, asymmetrical shapes, and other like shapes, may be used to produce powder compacts and cutting tool inserts having contiguous through-hole surfaces and corresponding peripheral shapes.

In various embodiments, processes for the production of cutting tool inserts may comprise removing a powder compacts from a powder compaction mold. The removal of powder compacts from powder compaction molds may involve, for example, an ejection mode of operation or a withdrawal mode of operation.

In an ejection mode of operation, the powder compaction mold is held in a fixed position and the top punch and the bottom punch can move independently. After the metallurgical powder is compressed between the bottom punch and the top punch to form a powder compact, the top punch (including the core pin) moves upwardly out of the powder compaction mold along the pressing axis. The powder compact is ejected from the powder compaction mold by the bottom punch, which moves upwardly through the powder compaction mold along the pressing axis.

During ejection, the core rod may be held stationary and only the bottom punch body moves upwardly through the powder compaction mold, thereby ejecting the powder compact from the powder compaction mold and the core rod simultaneously. Alternatively, the core rod may move upwardly with the powder compact (float) as the compact is ejected. Once the powder compact exits the powder compaction mold, the powder compact may experience a slight elastic expansion (i.e., green expansion or spring out), which causes the powder compact to release from the core rod. The core rod is then free to move downwardly along the pressing axis back into the bottom punch to resume a fill position.

An ejection mode of operation may be used after either a single-action press stroke or a double-action press stroke. During a single-action press stroke, the powder compaction mold and the bottom punch remain stationary and compaction is performed by the top punch moving along the pressing axis, which may be driven by the action of a press, for example. During a double-action press stroke, the powder compaction mold remains stationary and compaction is performed by the moving top punch and the oppositely moving bottom punch along the pressing axis. The opposed movement of the top punch and the bottom punch along the pressing axis during a double-action press stroke may also be driven by the action of a press, for example.

In a withdrawal mode of operation, the bottom punch is held stationary in a fixed position and the top punch and the powder compaction mold can move independently. After the metallurgical powder is compressed between the bottom punch and the top punch to form a powder compact, the top punch (including the core pin) moves upwardly out of the powder compaction mold along the pressing axis. The powder compaction mold moves downwardly along the pressing axis relative to the stationary bottom punch. The powder compact remains positioned on the face of the stationary bottom punch as the powder compaction mold moves downwardly along the pressing axis, thereby releasing the powder compact from the powder compaction mold. The core rod is held stationary until the powder compaction mold has fully withdrawn from the powder compact. Once the powder compaction mold has fully withdrawn from the powder compact, the powder compact may experience a slight elastic expansion (i.e., green expansion or spring out), which causes the powder compact to release from the core rod. The core rod is then free to move downwardly along the pressing axis back into the bottom punch.

In various embodiments, processes for the production of cutting tool inserts may comprise removing a powder compacts from a powder compaction mold using either an ejection mode of operation or a withdrawal mode of operation. In various embodiments, processes for the production of cutting tool inserts may further comprise sintering the removed powder compacts to form cutting tool inserts.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting and non-exhaustive embodiments described in this specification. In this manner, Applicant reserves the right to amend the claims during examination to add features as variously described in this specification, and such amendments comply with the requirements of 35 U.S.C. §112, first paragraph, and 35 U.S.C. §132(a).

What is claimed is:

1. A process for the production of cutting tool inserts, the process comprising:
positioning a bottom punch into a powder compaction mold, the bottom punch comprising:
a bottom punch body,
a bottom punch face located on a pressing end of the bottom punch body,
an internal channel disposed in the bottom punch body and opening at the bottom punch face, and
a core rod partially disposed in the internal channel, the core rod comprising a pressing end and a countersinking projection located on the pressing end, wherein the core rod partially extends through the opening of the internal channel and above the bottom punch face;
introducing a metallurgical powder into a mold cavity formed by the powder compaction mold and the bottom punch;
positioning a top punch into the powder compaction mold in an orientation opposed to the bottom punch, the top punch comprising:
a top punch body,
a top punch face located on a pressing end of the top punch body,
an internal channel disposed in the top punch body and opening at the top punch face, and
a core pin disposed in the internal channel, the core pin comprising a pressing end and a countersinking projection located on the pressing end, wherein the countersinking projection extends through the opening of the internal channel and below the top punch face; and
compressing the metallurgical powder between the bottom punch and the top punch to form a powder compact.

2. The process of claim 1, wherein the core rod countersinking projection and the core pin countersinking projection each comprise the same geometry in opposed orientation along a pressing axis.

3. The process of claim 1, wherein the core rod countersinking projection and the core pin countersinking projection each comprise an arcuately-shaped projection surface.

4. The process of claim 1, wherein the core rod is cylindrically-shaped and the core rod countersinking projection comprises an arcuately-shaped projection surface disposed around the circumference of the core rod at the pressing end, and wherein the core pin is cylindrically-shaped and the core pin countersinking projection comprises an arcuately-shaped projection surface disposed around the circumference of the core pin at the pressing end.

5. The process of claim 1, wherein the compressing of the metallurgical powder comprises:
moving the top punch along a pressing axis toward the bottom punch;
engaging the pressing ends of the core pin and the core rod to form a contiguous through-hole contouring surface, wherein the engaging core pin and core rod are co-axially aligned along the pressing axis; and
compacting the metallurgical powder between the bottom punch face and the top punch face to form the powder compact;
wherein the bottom punch face forms a bottom surface of the powder compact, the top punch face forms a top surface of the powder compact, a sidewall of the powder compaction mold forms a peripheral side surface of the powder compact, and the contiguous through-hole contouring surface forms a through-hole surface of the powder compact.

6. The process of claim 5, wherein the core rod countersinking projection and the core pin countersinking projection each comprise arcuately-shaped projection surfaces that together form the contiguous through-hole contouring surface.

7. The process of claim 6, wherein the contiguous through-hole contouring surface comprises a toroidal shape.

8. The process of claim 5, wherein the pressing end of the core pin engages the pressing end of the core rod and pushes the core rod along the pressing axis into the internal channel in the bottom punch body.

9. The process of claim 5, wherein, at the end of a press stroke, the through-hole contouring surface is located completely in the powder compaction mold along the pressing axis between the bottom punch face and the top punch face.

10. The process of claim 5, wherein, at the end of a press stroke, the engagement between the core pin projection and the core rod projection is located at the center plane of the powder compact along a thickness dimension.

11. The process of claim 5, wherein a top half of the through-hole surface of the powder compact is formed by the core pin countersinking projection, and wherein a bottom half of the through-hole surface of the powder compact is formed by the core rod countersinking projection.

12. The process of claim 1, further comprising:
removing the powder compact from the powder compaction mold; and
sintering the powder compact to form a cutting tool insert.

13. A process comprising sintering a powder compact made in accordance with the process of claim 1.

14. A powder compact made in accordance with the process of claim 1.

15. A cutting tool insert made in accordance with the process of claim 1.

16. The cutting tool insert of claim 15, the insert comprising:
a top surface;
a bottom surface; and
a countersunk through-hole comprising a contiguous surface connecting the top surface and the bottom surface.

17. The cutting tool insert of claim 16, wherein the countersunk through-hole comprises a toroidal surface.

18. A powder pressing apparatus for the production of cutting tool inserts comprising:
a bottom punch body comprising a bottom punch face located on a pressing end of the bottom punch body, and an internal channel disposed in the bottom punch body and opening at the bottom punch face;
a core rod partially disposed in the internal channel of the bottom punch body, the core rod comprising a pressing end and a counter-sinking projection located on the pressing end, wherein the core rod partially extends through the opening of the internal channel and above the bottom punch face;
a top punch body comprising a top punch face located on a pressing end of the top punch body, and an internal channel disposed in the top punch body and opening at the top punch face; and
a core pin disposed in the internal channel of the top punch body, the core pin comprising a pressing end and a countersinking projection located on the pressing end, wherein the countersinking projection extends through the opening of the internal channel and below the top punch face.

19. The powder pressing apparatus of claim 18, wherein the core rod countersinking projection and the core pin countersinking projection each comprise the same geometry.

20. The powder pressing apparatus of claim 18, wherein the core rod countersinking projection and the core pin countersinking projection each comprise arcuately-shaped projection surfaces.

21. The powder pressing apparatus of claim 18, wherein the core rod is cylindrically-shaped and the core rod countersinking projection comprises an arcuately-shaped projection surface disposed around the circumference of the core rod at the pressing end, and wherein the core pin is cylindrically-shaped and the core pin countersinking projection comprises an arcuately-shaped projection surface disposed around the circumference of the core pin at the pressing end.

22. The powder pressing apparatus of claim 18, wherein the pressing ends of the core pin and the core rod are configured to mutually engage during a press stroke to form a contiguous through-hole contouring surface.

23. The powder pressing apparatus of claim 22, wherein the core rod countersinking projection and the core pin countersinking projection each comprise arcuately-shaped projection surfaces that together form the contiguous through-hole contouring surface.

24. The powder pressing apparatus of claim 22, wherein the contiguous through-hole contouring surface comprises a toroidal shape.

25. A cutting tool insert comprising:
a top surface;
a bottom surface; and
a countersunk through-hole comprising a contiguous surface connecting the top surface and the bottom surface.

26. The cutting tool insert of claim 25, wherein the countersunk through-hole comprises a toroidal surface.
